(19) United States
(12) Patent Application Publication
(10) Pub. No.: US 2015/0235306 A1
(43) Pub. Date: Aug. 20, 2015

(54) METHOD AND SYSTEM FOR A SELLER TO LIST REAL PROPERTY

(71) Applicant: Joseph Sabella, East Islip, NY (US)

(72) Inventor: Joseph Sabella, East Islip, NY (US)

(21) Appl. No.: 14/624,973

(22) Filed: Feb. 18, 2015

Related U.S. Application Data
(60) Provisional application No. 61/941,808, filed on Feb. 19, 2014.

(51) Int. Cl. G06Q 30/08; G06Q 50/16

(52) U.S. Cl. CPC G06Q 30/08; G06Q 50/16

(57) ABSTRACT

According to some embodiments, a method and apparatus are provided to hire a real estate agent, the method and apparatus to receive a listing associated with a particular real estate property and transmit an indication of the received listing to a plurality of real estate agents. Bids associated with the listing are received from the plurality of real estate agents and the received bids are transmitted to the seller.

### BACKGROUND

When an owner of a house, condominium or other particular real estate property desires to sell their property, the property owner (e.g. a seller) will typically employ a real estate agent (e.g., a Realtor, an agent, a broker) and the real estate agent will facilitate the sale of the property. However, the process of selecting a real estate agent may be difficult. Typically, a seller may select a real estate agent by receiving recommendations from friends or relatives, or the seller may responded to an advertisement and, in turn, be contacted by a real estate agent. However, since each real estate agent typically requires a signed contract prior to representation, it may be difficult for a seller to learn about the capabilities of multiple real estate agents.

### BRIEF DESCRIPTION OF THE DRAWINGS

FIG. 1 illustrates a method according to some embodiments.

FIG. 2 illustrates an embodiment of a system.

FIG. 3 illustrates an embodiment of a system.

### DETAILED DESCRIPTION

With the advances in technology, the advent of the internet, interconnected systems and the popularity of mobile devices (e.g., tablets and smart phones) and applications (i.e., apps) it may be easier for sellers of real property to expose their property to potential buyers as well as real estate agents. Real property may comprise, but it is not limited to, a house, a condominium, a building, or raw land. To facilitate the sale of their property, a seller may transmit their listing data electronically using a mobile device that comprises an application specifically designed to walk the seller through a listing process.

In some embodiments, a seller may want to market their real property without the help of a real estate agent (i.e., a licensed professional real estate agent or broker). However, in other embodiments, the seller may want to market their property with the help of a licensed professional. The method and system described herein may guide a user (e.g., a seller) in selecting from a menu of “do it yourself” services associated with marketing real property that the user owns while protecting the user from unscrupulous real estate agents. For example, if the seller would like to market their property with the help of a real estate agent, the present method and apparatus may guide a seller in listing their real property by putting the listing out to bid so that a plurality of real estate agents may bid for the chance to represent the seller. However, the seller may not have any indication as to the trustworthiness of the real estate agents and, thus, the present method and system may protect the seller from unscrupulous real estate agents. The present system may also relate to a service that screens real estate agents and provides access to only the reliable and trustworthy real estate agents. In some embodiments, trustworthy real estate agents may enroll with the present system and may be given a membership to use the present system.

The listing of the seller's real property may be created using a mobile device. Using a mobile device's built-in GPS, an application residing the mobile device may identify a location of the seller's property. Once the location is verified via the seller, the application may query an online real estate database to retrieve information to populate fields such as address, legal description, tax information and a map location associated with the real estate to be sold. For example, if the real estate for sale was previously listed in a multi-listing service (“MLS”), the application may retrieve information to populate a new listing based on information from the MLS database. The application may populate all appropriate fields for the listing for marketing purposes such as, but not limited to, a number of bedrooms, bathrooms, total rooms, etc. In some embodiments, labeled picture fields may be uploaded from the mobile device to provide more detail about the property. In some embodiments, the seller may be guided as to which photos should be taken and uploaded. For example, the application may provide a checklist to indicate to the seller which features, based on a type of real estate that should be captured in an image.

After all appropriate data is entered and photographs taken, the seller may have an option of selecting a “do it yourself” plan, or the seller may put the listing out to bid to a plurality of real estate agents. In some embodiments, the seller may initiate both options.

In some embodiments, the “do it yourself” plan may include, but is not limited to, items such as the following:
automatically creating and populating a website associated with the real estate for sale.
automatically providing listing data to all major listing services/portals.
automatically publishing listing data in the local MLS database.
a professional lawn sign.
receiving a comparative market analysis (“CMA”) prepared by a licensed real estate professional.
a showing service.

One or more of the aforementioned items and services may be individually selected by the seller, and the seller may be guided through payment for the selected items or services.

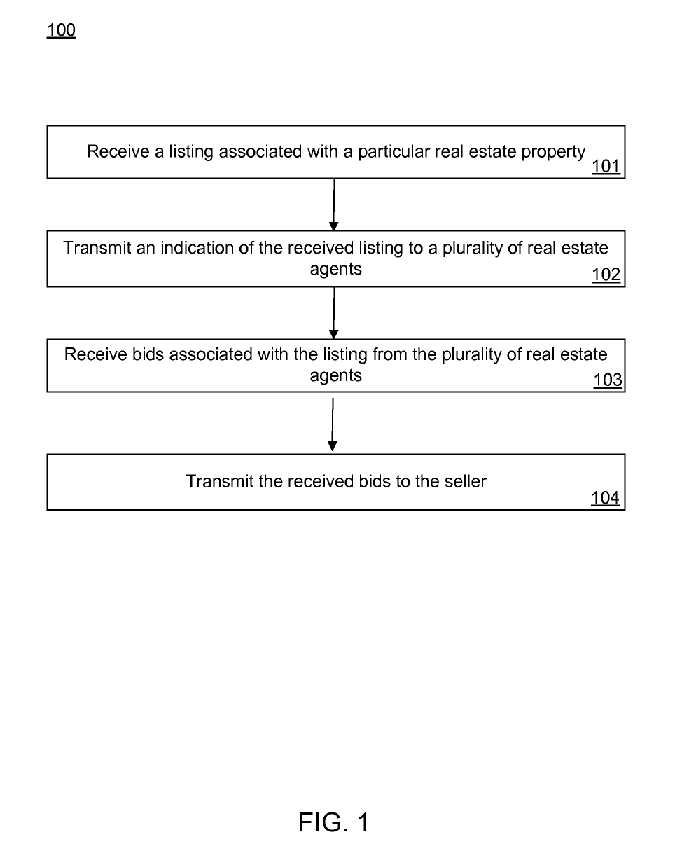

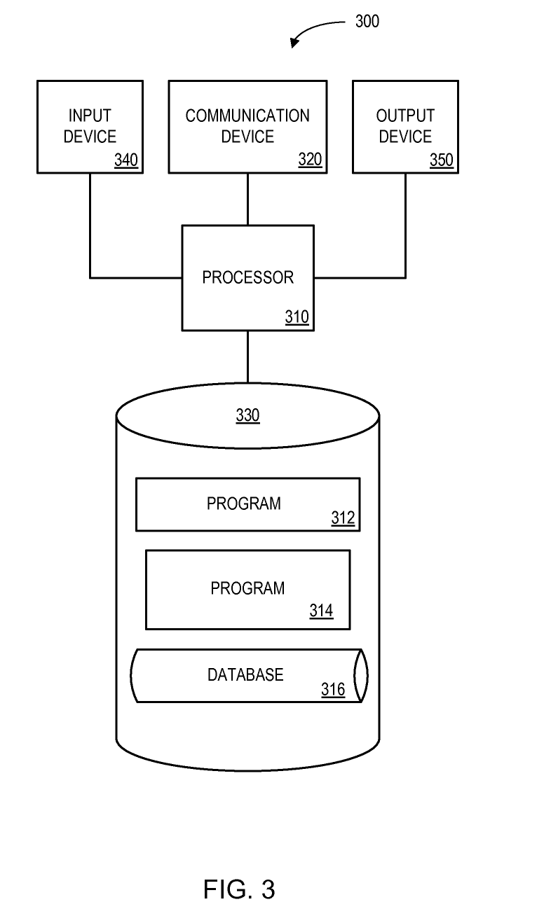

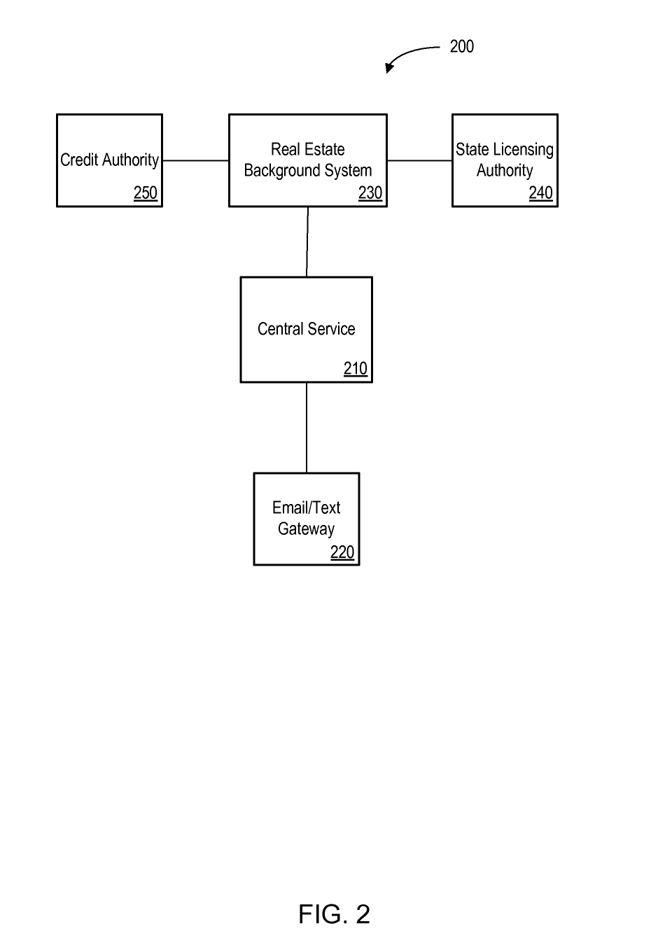

Referring now to FIG. 1, an embodiment of a method 100 is illustrated. The method 100 may relate to hiring a real estate agent, and the method 100 may be embodied on a non-transitory computer-readable medium. Furthermore, the method 100 may be performed by an apparatus such as, but not limited to, the system of FIG. 2 or the system of FIG. 3. The method 100 may relate to a real estate application that may be executed using a desktop computer, a laptop or a mobile device (e.g., a tablet or smart phone). The method may be associated with a real estate agent bidding on a property listing. At 101, a listing associated with a particular real estate property is received. The listing may be received at a central service, such as central service 310 of FIG. 3, from a seller, to facilitate a bidding process associated with real estate listings. The listing may comprise a plurality of data associated with the property such as, but not limited to, a location, description and photographs as described above.

At 102, an indication of the received listing is transmitted to a plurality of real estate agents. Real estate agents may be notified by text messages or emails each and every time a listing is put out for bid. For example, and referring to FIG. 3, the text messages or emails may be transmitted by a texting or email gateway 320.

At 103, bids associated with the listing are received from the plurality of real estate agents. Bids from real estate agents may be ranked on the real estate agents expertise and marketing efforts. For example, bids may be sorted based on a level of years of experience of the real estate agent and/or an indication of an amount of marketing dollars that the real estate agent may invest in the property or a value of the property to be sold based on a market evaluation performed by the real estate agent. Bids may comprise the real estate agent's contract terms and marketing plan.

Now referring to FIG. 3, an embodiment of a system 300 is illustrated. Bids may also comprise a security ranking for each real estate agent. For example, the central service may comprise a state issued identification for each real estate agent that has a potential to bid. In some embodiments, a real estate agent may only be allowed to bid if they meet a set of minimum criteria. The central service 310 may transmit a request to a real estate background system 330. The specific criteria may relate to the following set of rules:
The real estate agent must not have any complaints filed against them with a state licensing authority. The real estate background system 320, in this situation, may interface with the state licensing authority 340 to perform a query on each real estate agent. The real estate background system 320 may transmit a state issued identification for each real estate agent to the state licensing authority 340 and may receive an indication of whether or not any complaints have been filed against the real estate agent. If a complaint has been filed, the real estate agent will not be allowed to bid. For example, the real estate agent who has enrolled in the present system may have his membership terminated (e.g., database records associated with the real estate agent may indicate the real estate agent as being unsatisfactory) and the real estate agent may be automatically removed from a listing of real estate agents that will receive an indication of a received listing.
The real estate agent must have a credit score above a pre-determined score (e.g., 700). A credit score of a particular level may indicate a level of trustworthiness.
The real estate agent must list their active, sold and pending inventory on their profile. In this situation, the real estate background system 320 may download information from a web page associated with each real estate agent to determine if properties indicated as sold or pending are within a set time frame (i.e., 90 days) to determine if the web page is up to date. In some embodiments, the real estate background system 320 may compare the web page properties to an MLS database to determine an accuracy of the webpage.
The real estate agent must have three references that may be contacted.
The real estate agent must have at least three posted testimonials posted on a nationally known real estate related web page.
The real estate agent must provide a detailed marketing plan as well as available marketing options that are offered by the real estate agent.
The real estate agent must post their commission rates and length of time associated with their exclusive contracts.
The real estate agent must enter their profile via a web interface.

Once a real estate agent has met the set of minimum criteria and a background check has been performed, the real estate agents may be ranked based on the criteria (e.g., most trustworthy to least trustworthy) and the real estate agents may be provided access to a secure website where the agent may initiate a bid by clicking on a bid button associated with a listing. In response to clicking on the bid button, a bid form may be displayed to the agent, and the agent may fill out the bid form which may comprise including the agents contract terms and marketing plan. The contract terms may include a commission rate and the marketing plan may include amount of money that the real estate agent will spend to promote the seller's property.

Real estate agents may upload sample marketing documents and a comparative market analysis (“CMA”) for the seller to review. An experienced real estate agent that is furnished with detailed information and photographs provided by a seller, may be able to provide the seller with an accurate estimate of the value of the seller's property. That estimate (e.g., a CMA) may be uploaded to the site for the seller's review. Sellers may also upload listing agreements, disclosures and other legal documents that can be signed electronically. After the bid form is complete, the agent will click the submit button.

The received bids are transmitted to the seller at 104. A system, such as system 200, may email or text the seller to notifying them of a newly submitted bid. The email or text may include a link that may take the seller directly to the real estate agent's bid. The real estate agent's bid may be stored on a central service system such as central service 310. In response to receiving the bid, the seller may review the bid and either transmit an acceptance of the bid, schedule an appointment to meet the real estate agent (e.g., meet at the property) or reject the bid. If the seller accepts the bid, the seller and real estate agent may make arrangements to meet in person or execute the documents via the system. After the transaction is complete, the seller may rate their agent. Real estate agents may pay a one-time setup fee and each listing secured by a winning bid may carry a fee (e.g., a $150 fee).

In some embodiments, a seller may submit the terms (i.e., contract terms) that he is willing to accept as part of the submitted listing (e.g., commission rate and/or a length of the term of the contract). A real estate agent that is willing to accept the listing on the seller's terms may be a successful bidder, and the seller could enter into a contract with that agent or that agent's real estate company. For example, the seller may include a commission rate or length of the term of contract that the seller is willing to accept. In some embodiments, real estate agent profiles may be viewable by a seller, and the seller may browse real estate agent bios (e.g., via a website) and send an invite requesting that a particular agent bid on the seller's property (e.g., bid on representing the seller in a sale of the seller's real estate property). In some embodiments, an option to interact with real estate agents via video conferencing and to send/receive documents and electronic signatures may be provided to the seller. In some embodiments, an option to research and contact service providers (e.g., attorneys, home inspectors, title companies, movers, stagers, contractors, cleaning services, satellite, telephone and internet) may be provided to the seller.

Now referring to FIG. 2, FIG. 2 is a block diagram overview of a system 200 according to some embodiments. The system 200 may be associated with a server or service such as a central service. The system 200 comprises a processor 310, such as one or more commercially available Central Processing Units (CPUs) in the form of one-chip microprocessors, coupled to a communication device 320 configured to communicate via a communication network (not shown in FIG. 3). The communication device 320 may comprise a wired or wireless transceiver to send/receive data to external systems. The communication device 320 may be used, for example, as an input path to receive information about real estate properties. The system 300 further includes an input device 340 (e.g., a keyboard or touch screen for navigation of a web page or software application) and an output device 350 (e.g., a display).

The processor 310 communicates with a storage device 330. The storage device 330 may comprise any appropriate information storage device, including combinations of magnetic storage devices (e.g., a hard disk drive), optical storage devices, and/or semiconductor memory devices. The storage device 330 may store one or more programs 312/314 for controlling the processor 310. The processor 310 performs instructions of the program 312 and thereby operates in accordance with any of the embodiments described herein. In some embodiments, the storage device may comprise a computer-readable medium that may store processor-executable instructions to be executed by the processor 310. For example, a computer-readable medium may comprise a non-transitory tangible medium such as, but is not limited to, a compact disk, a digital video disk, flash memory, optical storage, random access memory, read only memory, or magnetic media.

The program 312 may be stored in a compressed, uncompiled and/or encrypted format. The program 312 may furthermore include other program elements, such as an operating system, a database management system, and/or device drivers used by the processor 310 to interface with peripheral devices.

As used herein, information may be “received” by or “transmitted” to, for example: (i) the system 300 from another device; or (ii) a software application or module within the system 300 from another software application, module, or any other source.

In some embodiments (such as shown in FIG. 3), the storage device 330 stores a database 316 (e.g., including information associated with real estate.). In some embodiments, the database 316 may comprise, but is not limited to, a FILEMAKER database. Moreover, various databases might be split or combined in accordance with any of the embodiments described herein. In some embodiments, the system 300 may comprise an onboard database and/or may connect to a remote database. In some embodiments, the database 316 may be onboard and/or remote (e.g., a central database that multiple apparatuses may access).The apparatus may also be linked to one or more multi-listing service (“MLS”) databases.

Various modifications and changes may be made to the foregoing embodiments without departing from the broader spirit and scope set forth in the appended claims. The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

What is claimed is:

1. A method of hiring a real estate agent, the method comprising:
receiving a listing associated with a particular real estate property;
transmitting, via a processor, an indication of the received listing to a plurality of real estate agents;
receiving bids associated with the listing from the plurality of real estate agents; and
transmitting the received bids to the seller.

2. The method of claim 1, wherein prior to transmitting an indication of the received listing to the plurality of real estate agents the method comprises,
transmitting information associated with each of the plurality of real estate agents to a real estate background system,
receiving information from the real estate background system regarding each of the plurality of real estate agents,
determining if each of the plurality of real estate agents meet specific criteria, and
in a case where the one of the plurality of real estate agents fails to meet specific criteria, the one of the plurality of real estate agents is indicated as unsatisfactory and is removed from a listing of real estate agents to receive the indication of the received listing.

3. The method of claim 2, where the specific criteria comprises a received indication that no complaints were filed against each of the plurality of real estate agents via a state licensing authority and an indication that the commission rates and length of time associated with their exclusive contracts of the each of the plurality of real estate agents real estate agents have been posted.

4. The method of claim 1, wherein the listing associated with a particular real estate property comprises contract terms that a seller of the particular real estate property is willing to accept.

5. The method of claim 1, wherein transmitting the indication of the received listing to a plurality of real estate agents is based on an invite requesting that a particular agent bid on the seller's particular real estate property.

6. A non-transitory computer-readable medium comprising instructions to hire a real estate agent, the method comprising:
receiving a listing associated with a particular real estate property;
transmitting, via a processor, an indication of the received listing to a plurality of real estate agents;
receiving bids associated with the listing from the plurality of real estate agents; and
transmitting the received bids to the seller.

7. The medium of claim 6, wherein prior to transmitting an indication of the received listing to the plurality of real estate agents the method comprises,
transmitting information associated with each of the plurality of real estate agents to a real estate background system,
receiving information from the real estate background system regarding each of the plurality of real estate agents,
determining if each of the plurality of real estate agents meet specific criteria, and
in a case where the one of the plurality of real estate agents fails to meet specific criteria, the one of the plurality of real estate agents is indicated as unsatisfactory and is removed from a listing of real estate agents to receive the indication of the received listing.

8. The medium of claim 7, where the specific criteria comprises a received indication that no complaints were filed against each of the plurality of real estate agents via a state licensing authority and an indication that the commission rates and length of time associated with their exclusive contracts of the each of the plurality of real estate agents real estate agents have been posted.

9. The medium of claim 6, wherein the listing associated with a particular real estate property comprises contract terms that a seller of the particular real estate property is willing to accept.

10. The medium of claim 6, wherein transmitting the indication of the received listing to a plurality of real estate agents is based on an invite requesting that a particular agent bid on the seller's particular real estate property.

11. An apparatus comprising:
a processor;
a non-transitory computer-readable medium comprising instructions to hire a real estate agent, the method comprising:
receiving a listing associated with a particular real estate property;
transmitting, via the processor, an indication of the received listing to a plurality of real estate agents;
receiving bids associated with the listing from the plurality of real estate agents; and
transmitting the received bids to the seller.

12. The apparatus of claim 11, wherein prior to transmitting an indication of the received listing to the plurality of real estate agents the method comprises,
transmitting information associated with each of the plurality of real estate agents to a real estate background system,
receiving information from the real estate background system regarding each of the plurality of real estate agents,
determining if each of the plurality of real estate agents meet specific criteria, and
in a case where the one of the plurality of real estate agents fails to meet specific criteria, the one of the plurality of real estate agents is indicated as unsatisfactory and is removed from a listing of real estate agents to receive the indication of the received listing.

13. The apparatus of claim 13, where the specific criteria comprises a received indication that no complaints were filed against each of the plurality of real estate agents via a state licensing authority and an indication that the commission rates and length of time associated with their exclusive contracts of the each of the plurality of real estate agents real estate agents have been posted.

14. The apparatus of claim 11, wherein the listing associated with a particular real estate property comprises contract terms that a seller of the particular real estate property is willing to accept.

15. The apparatus of claim 11, wherein transmitting the indication of the received listing to a plurality of real estate agents is based on an invite requesting that a particular agent bid on the seller's particular real estate property.
